(19) United States
(12) Patent Application Publication
(10) Pub. No.: US 2008/0192575 A1
(43) Pub. Date: Aug. 14, 2008

(54) Method, Apparatus and Computer Program Product for Providing a Sonar History

(75) Inventor: Aaron Coleman, Broken Arrow, OK (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Navico Inc.

(21) Appl. No.: 11/674,814

(22) Filed: Feb. 14, 2007

(51) Int. Cl. G01S 15/89; G01S 15/96

(52) U.S. Cl. 367/115

(57) ABSTRACT

An apparatus for providing a sonar history includes a storage media and a function execution element. The storage media may be configured to store information associated with sonar signal data to thereby create a continuous record. The function execution element may be configured to receive an instruction from a user and to perform a function with respect to the continuous record, in response to, and based on the instruction. Receiving the instruction and performing the function may occur as the continuous record is created.

### FIELD OF THE INVENTION

Embodiments of the present invention relate generally to sonar systems, and more particularly, to providing mechanism by which to provide a sonar history.

### BACKGROUND OF THE INVENTION

Sonar has long been used to detect waterborne or underwater objects. For example, sonar devices may be used to determine bottom topography, detect fish or other waterborne contacts, locate wreckage, etc. In this regard, due to the extreme limits to visibility underwater, sonar is typically the most accurate way for individuals to locate objects underwater. Since the development of sonar, display technology has also been improved in order to enable better interpretation of sonar data. Strip chart recorders and other mechanical output devices have been replaced by, for example, digital displays such as LCDs (liquid crystal displays). Current display technologies continue to be improved in order to provide, for example, high quality sonar data on multi-color, high resolution displays having a more intuitive output than early sonar systems were capable of producing.

However, current sonar systems typically only display high-quality sonar data for a limited period of time, after which the data may be lost. For example, a typical display may illustrate sonar data gathered over the last few minutes, but when the data reaches the edge of the display, the data is lost. Additionally, although some sonar systems permit an operator to pause a sonar display for a period of time in order to inspect a particular screen image, real-time data may be lost while the display is paused. And if such data is not lost, it may only be stored in paper form via a strip chart.

Accordingly, it may be desirable to develop a sonar system that is capable of providing a sonar history that is easily accessible and upon which various functions may be performed. Moreover, it may be desirable to provide a sonar history that is not reliant upon paper.

### BRIEF SUMMARY OF THE INVENTION

Accordingly, in order to provide a historical sonar record that cures the deficiencies noted above, a method, computer program product and apparatus for providing a sonar history are described herein in accordance with exemplary embodiments of the present invention. Exemplary embodiments of the present invention employ a storage media for continuously storing sonar data and also provide a user with the ability to perform functions on stored sonar data while continuing to record current data. Thus, no data is undesirably lost while performing functions on existing stored data.

In one exemplary embodiment, a method for providing a sonar history is provided. The method includes storing information associated with sonar signal data to thereby create a continuous record, receiving an instruction from a user, and performing a function with respect to the continuous record in response to, and based on, the instruction. Receiving an instruction and performing a function may occur as the continuous record is created.

In another exemplary embodiment, a computer program product for providing a sonar history is provided. The computer program product includes at least one computer-readable storage medium having computer-readable program code portions stored therein. The computer-readable program code includes multiple executable portions. The first executable portion is for storing information associated with sonar signal data to thereby create a continuous record. The second executable portion is for receiving an instruction from a user. The third executable portion includes instructions for performing a function with respect to the continuous record in response to, and based on, the instruction. Receiving an instruction and performing a function may occur as the continuous record is created.

In yet another exemplary embodiment, an apparatus for providing a sonar history is provided. The apparatus includes a storage media and a function execution element. The storage media may be configured to store information associated with sonar signal data to thereby create a continuous record. The function execution element may be configured to receive an instruction from a user and to perform a function with respect to the continuous record, in response to, and based on the instruction. Receiving the instruction and performing the function may occur as the continuous record is created.

Embodiments of the invention provide users with an ability to manipulate or examine data while continuing to store current data. As a result, the user may study or review past data without being concerned over the loss of newly acquired data.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a basic block diagram illustrating a marine system that may benefit from exemplary embodiments of the present invention;

FIG. 2 illustrates a basic block diagram of a head unit according to an exemplary embodiment of the present invention;

FIG. 3 illustrates a functional block diagram of an apparatus for providing a sonar history according to an exemplary embodiment of the present invention;

FIG. 4 illustrates an example of a display driven according to an exemplary embodiment of the present invention; and

FIG. 5 is a flowchart including various operations of a method of providing a sonar history according to one exemplary embodiment of the present invention.

### DETAILED DESCRIPTION OF THE INVENTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

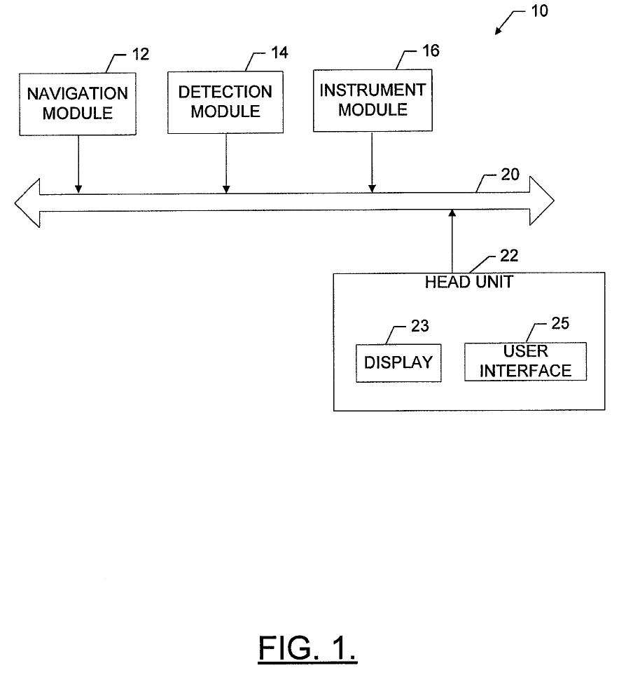

FIG. 1 is a basic block diagram illustrating a marine system 10 that may benefit from exemplary embodiments of the present invention. As shown, the marine system 10 may include a number of different modules, each of which may comprise any device or means embodied in either hardware, software, or a combination of hardware and software configured to perform one or more functions. For example, the marine system may include a navigation module 12, a detection module 14, an instrument module 16 and/or numerous other peripheral devices. One or more of the modules may be configured to communicate with one or more of the other modules, and/or with a head unit 22 that may be configured to process and/or display data, information or the like from one or more of the modules. The modules and/or head unit may be configured to communicate with one another in any of a number of different manners including, for example, via a network 20. In this regard, the network 20 may be any of a number of different communication backbones or frameworks including, for example, the NMEA 2000 framework.

The head unit 22 may include a display 23 configured to display images, and a user interface 25 configured to receive an input from a user of the head unit 22. The display 23 may be, for example, a conventional LCD (liquid crystal display) or any other suitable display known in the art upon which images may be rendered. And the user interface 25 may include, for example, a keyboard, keypad, function keys, mouse, scrolling device, touch screen, or any other mechanism by which a user may interface with the head unit 22.

The navigation module 12 may include any of a number of different navigation devices configured to receive navigation information from one or more external sources and generate location information indicative of the location of, for example, a marine craft employing the marine system 10. For example, the navigation module 12 may include one or more GPS (global positioning system) or other satellite navigation system modules, inertial navigation system modules, terrestrial navigation system modules (e.g., LORAN-C), etc.

The detection module 14 may include any of a number of different detection and ranging systems for detecting vessels, structures or aids to navigation. For example, the detection module 14 may include a sonar system that uses sound wave transmissions to determine water depth or detect fish and/or other waterborne contacts. Additionally or alternatively, for example, the detection module 14 may include a conventional radar system that uses radio frequency transmissions to determine ranging information and other position related information associated with surface or airborne vessels or aids to navigation. It should be noted that although FIG. 1 shows the detection module 14 as being a separate element from the head unit 22 which is in communication with the head unit 22 via the network 20, the detection module 14 could alternatively be a portion of the head unit 22 or be directly in communication with the head unit 22.

The instrument module 16 may be configured to receive analog or digital information related to a parameter measured at a particular device, and communicate that information to the network 20 in a digital format. For example, the instrument module 16 may be configured to receive information from numerous sensors configured to measure parameters at numerous corresponding shipboard devices such as fuel level, speed, engine RPM (revolutions per minute), engine fluid temperature and/or pressure, battery state of charge, etc. The instrument module 16 may therefore include any of a number of different devices such as, for example, a tachometer, speedometer, thermometer, pressure gauge, volt meter, fuel level sensor, etc. Where applicable, the instrument module 16 may include analog-to-digital conversion capabilities to communicate digital data to the network 20.

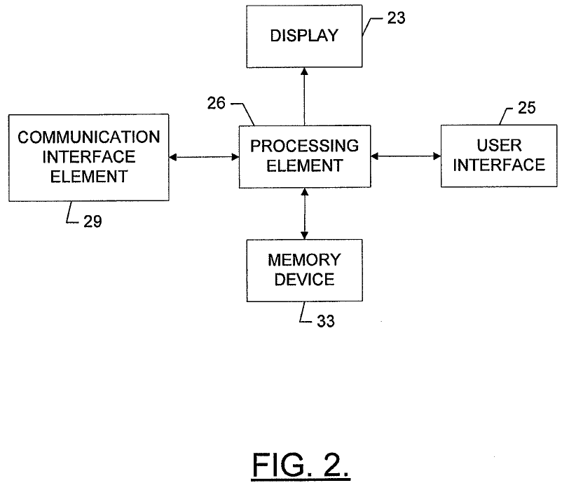

As indicated above, the head unit 22 may be configured to receive data, information or the like via the network 20 and process and/or display the received data. FIG. 2 illustrates a basic block diagram of the head unit 22 according to an exemplary embodiment of the present invention. As shown, in addition to a display 23 and user interface 25, the head unit 22 may include a processing element 26, communication interface element 29 and memory device 33. The memory device 33 may include, for example, volatile or non-volatile memory. The memory device 33 may be configured to store information, data, applications, instructions or the like for enabling the head unit to carry out various functions in accordance with exemplary embodiments of the present invention. For example, the memory device 33 could be configured to buffer input data for processing by the processing element 26. Additionally or alternatively, the memory device 33 could be configured to store other data including, for example, image data.

The processing element 26 may be embodied in many ways. For example, the processing element 26 may be embodied as a processor, a coprocessor, a controller or various other processing means or devices including integrated circuits such as, for example, an ASIC (application specific integrated circuit). In an exemplary embodiment, the processing element 26 may be configured to execute instructions stored in the memory device 33 or otherwise accessible to the processing element 26. In an exemplary embodiment, the processing element 26 may be configured to execute a gauge application stored in the memory device 33 or otherwise accessible to the processing element 26. Meanwhile, the communication interface element 29 may be embodied as any device or means embodied in either hardware, software, or a combination of hardware and software that is configured to receive and/or transmit data from/to the network 20.

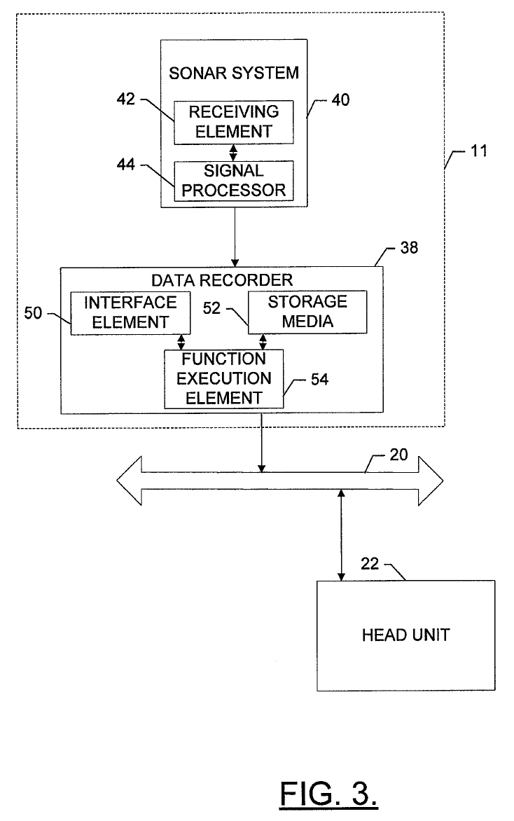

FIG. 3 illustrates a functional block diagram of a system 11 for providing a sonar history in accordance with exemplary embodiments of the present invention. The system 11 may include a data recorder 38, and a detection module 14 (see FIG. 1) comprising a sonar system 40, in communication with the head unit 22 via the network 20. Although the data recorder 38 of FIG. 3 is illustrated as a separate device, the data recorder 38 could alternatively be a portion of either the sonar system 40 or the head unit 22. Additionally, although the data recorder 38 or FIG. 3 is illustrated as being a gateway device that communicates information between the network 20 and the sonar system 40, the data recorder 38 could be a device in communication with both the head unit and the sonar system 40 via the network 20. The data recorder 38 could also alternatively be a gateway device with respect to the head unit 22 such that the data recorder communicates information between the network 20 and the head unit 22. Furthermore, the sonar system 40 could also be a portion of the head unit 22 itself. In other words, the head unit 22 according to an exemplary embodiment could include one or both of the sonar system 40 and the data recorder 38. As such, elements of the system 11 may be corresponding portions of the head unit 22 or may otherwise be in communication with the head unit 22 via a direct connection or via the network 20.

As shown in FIG. 3, the sonar system 40 may include a receiving element 42 and a signal processor 44 configured to communicate with one another. The receiving element 42 may be any means or device configured to receive sound energy and convert such energy into corresponding sonar signal data. For example, the receiving element 42 may be an active or passive sonar element. In this regard, when the receiving element 42 is an active sonar element, the receiving element 42 may include a transponder configured to emit sound energy into water and subsequently detect sonar signal data corresponding to measurements of echo signals produced in response to returns of the emitted sound energy, the emitting sound energy having reflected off of various objects in the water. Alternatively, the transponder could be a device separate from the receiving element 42. The signal processor 44 may be a processing element similar to the processing element 26 described above, except that the signal processor 44 may be configured to process the sonar signal data received from the receiving element 42 in order to produce corresponding display data that may be communicated to a display device such as, for example, the display 23 of the head unit 22.

The data recorder 38 may be embodied as any device or means embodied in either hardware, software, or a combination of hardware and software that is configured to store or otherwise record information associated with sonar signal data (“sonar information”). The data recorder may record sonar information in a real-time fashion such that the stored sonar information may be reviewed, replayed or otherwise have functions executed thereupon, as desired, even as the data recorder records current sonar information. In other words, the data recorder 38 may record sonar information such that current sonar information (information associated with current sonar signal data) may be continuously stored while previously-stored sonar information (information associated with previous sonar signal data) may be played, rewound, fast forwarded or otherwise accessed by a user. The sonar information may include, for example, the sonar signal data and/or corresponding display data. The sonar information may be selectively communicated from the data recorder 38 to the head unit 22 or another network device for further processing, or directly communicated to the head unit 22 for display in accordance with a user-selected function, as described in greater detail below. In either event, however, the sonar information may be communicated while the data recorder 38 continuously stores current sonar information.

As shown in FIG. 3, in an exemplary embodiment, the data recorder 38 may include an interface element 50, a storage media 52 and a function execution element 54. The interface element 50 may be embodied as any device or means embodied in either hardware, software, or a combination of hardware and software that is configured to receive a user input (e.g., via the user interface 25) instruction for directing the function execution element 54 to perform a function with respect to sonar information. Examples of instructions may include play, pause, rewind, fast forward, and return to live action, and an instruction to call up or drop a cursor.

The storage media 52 may be any volatile and/or non-volatile memory device capable of storing the sonar information. In an exemplary embodiment, the storage media 52 may be a circular buffer with a relatively large storage capability such that, after a period of time, an amount of older sonar information may be deleted in order to enable storage of a corresponding amount of current sonar information. It is envisioned, for example, that the storage media 52 may be of sufficient size to enable the storage of many hours or even days of sonar information. As such, the storage media 52 may perform long term storage of sonar information and, as will be described in greater detail below, corresponding other information, thereby forming a continuous record of stored information in order to enable functions to be performed on the stored information. It should also be noted that although the storage media 52 is shown in FIG. 3 as being a part of the data recorder 38, the storage media 52 could alternatively be the memory device 33 of the head unit 22.

The function execution element 54 may be embodied as any device or means embodied in either hardware, software, or a combination of hardware and software that is configured to perform one or more functions with respect to the sonar information, such as function(s) as determined by user instruction(s) (via, e.g., the interface element 50). The function(s) may include any of a number of basic functions such as, but not limited to, rewinding, playing, pausing, fast forwarding, etc. Thus, for example, if a particular feature of interest is encountered in a live display of sonar information on the head unit 22, a pause function may be executed so that the display 23 may be paused to enable further examination of the particular feature of interest. Alternatively, a rewind function may be executed to rewind the display data back to a time corresponding to the particular feature of interest. The display data may then be fast forwarded until current time, or the live display, is reached. Alternatively, at any time while viewing paused or rewound display data (i.e., stored sonar information), a function may be executed to return to a real-time or current display.

The function execution element 54 may also be configured to perform several more complex functions. For example, the sonar information may include supplemental information such as chart data, GPS data, or instrumentation data such as, for example, time, speed, course over ground, track, heading, fuel remaining, water temperature, salinity, depth, live well temperature, etc. The supplemental information may be associated with corresponding sonar information. As such, the function execution element 54 may be configured to perform search functions for particular supplemental information, and/or output sonar information to a display (e.g., display 23) if such information corresponds to supplemental information meeting particular user defined criteria. Thus, for example, criteria such as starting and ending times may be selected for display. Alternatively, data corresponding to a particular depth band may be selected for display. As yet another alternative, a rate of change of depth may be selected for displaying corresponding data. In an exemplary embodiment in which GPS data is integrated, the location where the corresponding data was acquired could be indicated on a chart or on a stored track.

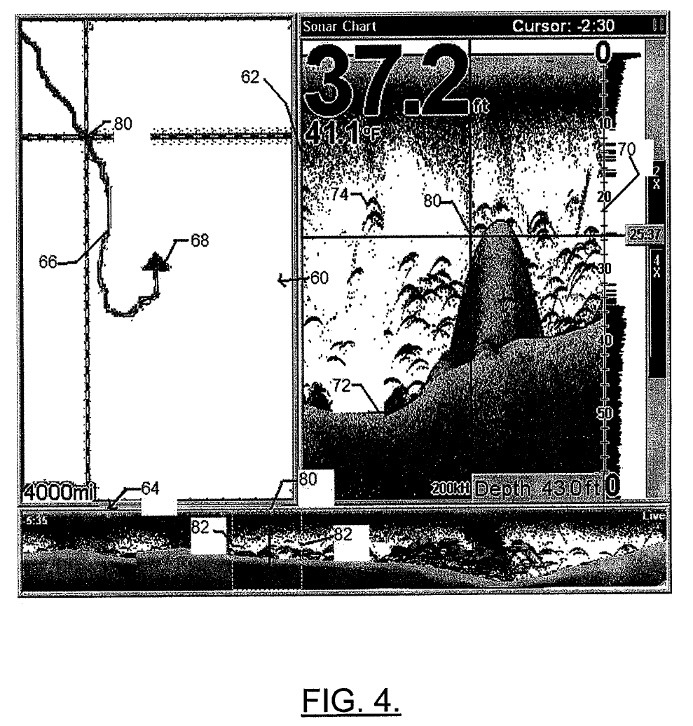

In an exemplary embodiment, the interface element 50 may be configured to receive an input from a scrolling device (e.g., scrolling device of user interface 25). In this regard, the scrolling device could be used to move a cursor across a timeline of stored or historical display data in order to select a point along the timeline showing historical data. At the selected point, one of the functions described above could be performed. The stored or historical display data could include, for example, either or both of sonar display data and corresponding chart display data. In an exemplary embodiment, the head unit 22 may be configured to display both chart and sonar data as shown, for example, in FIG. 4. FIG. 4 illustrates a display driven in accordance with input received from the function execution element 54 according to an exemplary embodiment of the present invention. As shown in FIG. 4, in one exemplary embodiment, the display may include a charted data window 60, a sonar display window 62, and a historical sonar data window 64. Although FIG. 4 shows an example in which each of the charted data window 60, the sonar display window 62 and the historical sonar data window 64 are displayed simultaneously, it may alternatively be possible to display any combination of the above mentioned windows, alone or in further combination with other windows not discussed herein. Thus, for example, any one of the charted data window 60, the sonar display window 62 or the historical sonar data window 64 could alternatively be displayed in a full-screen context.

The charted data window 60 may include chart data provided, for example, in response to data received from the navigation module 12 and/or the detection module 14 (e.g., sonar system 40). For example, the charted data window 60 may display vessel track, contact data, charted depth, GPS data, aids to navigation, scale information, etc. In the exemplary embodiment of FIG. 4, the charted data window 60 includes track data 66 and a current vessel position marker 68, which may also be indicative of vessel heading.

The sonar display window 62 may display a selected period of display data for detailed display. Features which may be included in the detailed display provided by the sonar display window 62 may include, for example, a depth scale 70, bottom echo-return data 72, contact echo-return data 74, etc. As shown in FIG. 4, older data displayed in the sonar display window 62 may be positioned on the left side of the window as viewed by a user, while newer data displayed in the sonar display window 62 may be positioned on the right side of the of the window as viewed by a user. Other information may also be included such as temperature data, depth data, frequency data, etc.

The historical sonar data window 64 may provide a display of data over a pre-selected period of time. For example, the pre-selected period of time may correspond to a trip or a period of time defined by default or the user. In an exemplary embodiment, the farthest right portion of the historical sonar data window 64 may correspond to live data at the current time, and the farthest left portion of the historical sonar data window 64 may correspond to the oldest data at the earliest time within the pre-selected period of time. Data in between the right and left represent a continuous representation of data gathered between the current time and the earliest time within the pre-selected period of time. Thus, the historical sonar data window 64 may display data corresponding to historical sonar signal data that has been stored over an extended period of time, and is continuously updated by the storage of sonar information. As an alternative, the historical sonar data window 64 may be configured to display stored data in a wrap-around manner, such as by connecting the oldest data to the newest data in a continuous fashion. In such instances, a portion of the display currently viewable on the sonar display window 62 may be centrally located while the ends indicate data that is farthest from the currently viewable portion.

In an exemplary embodiment, the sonar display window 62 may display (e.g., by default) live data such as the current sonar data and a selectable amount of sonar data received just prior to the receipt of the current sonar data (e.g., a preceding two minutes of data). As such, when displaying live data, the sonar display window may be continuously updated to display the current sonar data and the preceding two minutes of sonar data. The sonar display window 62 may be configured to display a more detailed or “zoomed in” version of a portion of the data displayed in the historical sonar data window 64. In an exemplary embodiment, when a user provides an input to call up a cursor 80, the sonar display window 62 may be paused such that the display is no longer continuously updated and the cursor 80 is displayed. In an exemplary embodiment, the cursor 80 may also appear simultaneously at corresponding positions on one or both the charted data window 60 and the historical sonar data window 64. While the cursor 80 is activated, the charted data window 60 and/or the historical sonar data window 64 may continue to update in response to newly received data. However, the sonar display window 62 may remain paused with the cursor 80 displayed at the center of the sonar display window 62. In such instances, the cursor 80 may also appear on either or both of the charted data window 60 and the historical sonar data window 64 at a corresponding location to that displayed on the sonar display window 62.

In an exemplary embodiment, the cursor 80 may be scrolled over historical sonar data and/or chart data (e.g., the track data 66), and display data corresponding to the position of the cursor 80 may be displayed on the sonar display window 62. In other words, particular locations or positions (temporal or geographic) on the charted data window 60 and/or the historical sonar data window 64 may be scrolled over for selection for display on the sonar display window 62. In an exemplary embodiment, particular locations or positions may also be marked using the cursor 80, such as by instituting a marking function in association with the cursor 80. The marking may continue to appear at the corresponding location or position even after real time data display is restored. Accordingly, for example, if an interesting feature is noticed on the sonar display window 62, a marker may be placed on the location at which the interesting feature was observed. Thus, at a later time, the cursor 80 may be scrolled to a location of the marker and the sonar display window 62 will display the same sonar display data that was originally displayed at the marked location. Additionally, the cursor 80 may show the position of the vessel at the marked location on the charted data window 60 and as well as the position of the marked location with respect to other historical data on the historical sonar data window 64. Marked locations could correspond to waypoints on a chart. Text entries could also be added to a marker to provide information associated with the marker. In one exemplary embodiment, a corresponding sonar display window may be called up automatically when the cursor is passed over a particular part of the track data 66.

In an exemplary embodiment, when the cursor 80 is taken down (e.g., when an exit is performed from the scrolling function), the display of the sonar display window 62 may return to real time operation. As shown in FIG. 4, when the cursor 80 is scrolled over historical sonar data, indicators 82 may be displayed on the historical sonar data window 64 to define the selected period of display data which is correspondingly displayed on the sonar display window 62. The indicators 82 may be, for example, positioned on opposite sides of the cursor 80 to define a corresponding start time for data display on the sonar display window 62, and a corresponding end time for data display on the sonar display window 62. As also seen in FIG. 4, textual output may be displayed on the sonar display window 62 for the depth (e.g., 43.0 ft) and frequency (e.g., 200 kHz) corresponding to cursor position within the sonar display window 62.

In an exemplary embodiment, the data recorder 38 may be configured to control a display function in order to compress parts of a sonar display that are farthest from real-time data and/or farthest from the displayed data position if data other than real-time or current data is being displayed. Display time may vary with a ping rate. However, if the ping rate is such that a conventional display may only show the last minute of data, exemplary embodiments of the present invention may provide for additional compressed data to be displayed. For example, the last minute of data may be displayed normally and a selected period of additional data may be displayed with linearly or nonlinearly increasing compression as time from the last minute of data increases. Alternatively, an entire trip could be displayed with either linear or nonlinear compression of past data. Accordingly, when, for example, the cursor 80 is utilized to select a portion of stored data corresponding to a particular time for display, portions of the stored data that are farthest from the particular time may be compressed (in one or both directions) in either a linear or nonlinear manner. In an exemplary embodiment, the user may select rates of compression, time periods for which various rates of compression apply, and/or linear or nonlinear compression, etc.

Thus, for example, the historical sonar data window 64 could display data between the indicators 82 with a particular scale representation. Meanwhile, data outside of the indicators could be compressed at portions near the right and left edges of the displayed historical sonar data. Alternatively, compression of data outside of the indicators 82 may be increasingly compressed on a linear or nonlinear scale as such data increases in temporal distance from the indicators 82.

In yet another exemplary embodiment, sonar information stored in the storage media 52 may be communicated to another device, such as to an external storage device in a file format. The sonar information may be communicated to any device in communication with the network 20 and/or to a device in direct communication with the data recorder 38. Accordingly, large amounts of historical sonar data may be permanently stored.

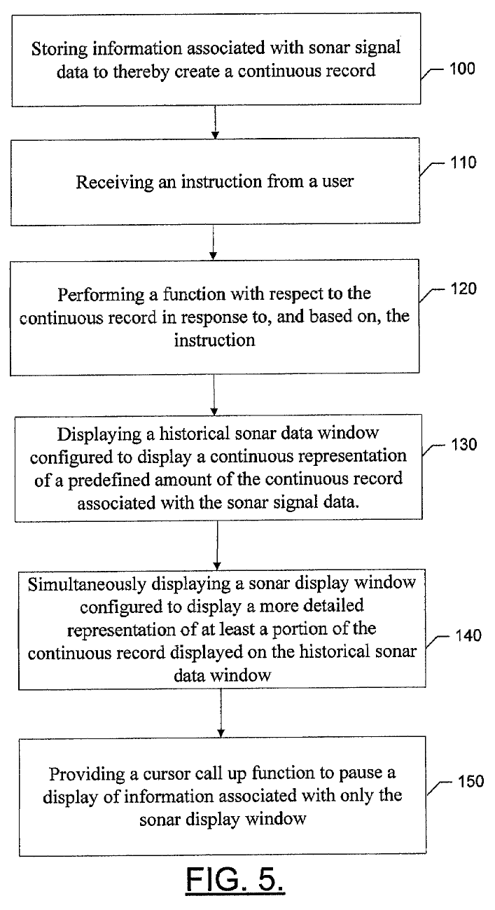

FIG. 5 is a flowchart of a system, method and program product according to an exemplary embodiment of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of, for example, the head unit, sonar system, or data recorder and executed by a built-in processor in the head unit, sonar system, or data recorder. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method of providing a sonar history, as shown in FIG. 5, includes storing information associated with sonar signal data to thereby create a continuous record (e.g., of stored sonar information) at operation 100. At operation 110, an instruction may be received from a user. At operation 120, a function may be performed with respect to the continuous record in response to, and based on, the instruction. The receipt of the instruction and the performing of the function may occur as the continuous record is created. In an exemplary embodiment, the information could be stored in a circular buffer such that, when the circular buffer is full, stored information that is oldest is deleted to enable current information to be stored. Exemplary functions which could be performed include, but are not limited to controlling a continuous display of the information such as by pausing a display of the sonar information, or performing a rewind or fast forward function to display data corresponding to previously stored sonar information. The method could further include displaying a historical sonar data window configured to display a continuous representation of a predefined amount of the stored sonar information (e.g., the continuous record) at operation 130. At operation 140, a sonar display window configured to display a more detailed representation of at least a portion of the continuous record displayed on the historical sonar data window may be simultaneously displayed. A cursor call up function may be provided at operation 150 in order to pause a display of information associated with only the sonar display window. The cursor call up function may simultaneously display a cursor at corresponding locations on both the sonar display window and the historical sonar data window. Indicators may also be displayed on the historical sonar data window to indicate a start time and stop time for data displayed on the sonar display window. In one exemplary embodiment, a charted data window configured to display a representation of navigation or detection data may be displayed simultaneously with one or both of the historical sonar data display and the sonar display window. In another exemplary embodiment, at least a portion of data displayed on the historical sonar data window may be compressed.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of providing a sonar history, the method comprising:
storing information associated with sonar signal data to thereby create a continuous record;
receiving an instruction from a user; and
performing a function with respect to the continuous record in response to, and based on, the instruction,
wherein receiving the instruction and performing the function occur as the continuous record is created.

2. The method of claim 1, wherein storing the information comprises continuously storing the information in a circular buffer.

3. The method of claim 1, wherein performing the function comprises controlling a continuous display of the information.

4. The method of claim 3, wherein controlling the continuous display comprises pausing, rewinding or fast forwarding a continuous display of the information.

5. The method of claim 1, further comprising displaying, in a historical sonar data window, a continuous representation of a predefined amount of the continuous record.

6. The method of claim 5, further comprising displaying, in a sonar display window, a more detailed representation of at least a portion of the continuous representation of the predefined amount of the continuous record in the historical sonar data window.

7. The method of claim 6, further comprising displaying, in a charted data window, a representation of navigation or detection data.

8. The method of claim 7, wherein the representation of navigation or detection data and the more detailed representation are simultaneously displayed with the continuous representation.

9. The method of claim 6, further comprising pausing the display of the more detailed representation, wherein pausing the display includes displaying a cursor at a location in the sonar display window, and simultaneously displaying a cursor at a corresponding location in the historical sonar data window.

10. The method of claim 9, wherein pausing the display further includes displaying indicators in the historical sonar data window, the indicators being positioned at start and stop times for the more detailed representation in the sonar display window.

11. The method of claim 6, further comprising compressing at least a portion of the continuous representation in the historical sonar data window.

12. A computer program product for providing a sonar history, the computer program product comprising at least one computer-readable storage medium having computer-readable program code portions stored therein, the computer-readable program code portions comprising:
a first executable portion for storing information associated with sonar signal data to thereby create a continuous record;
a second executable portion for receiving an instruction from a user; and
a third executable portion for performing a function with respect to the continuous record in response to, and based on, the instruction,
wherein receiving the instruction and performing the function occur as the continuous record is created.

13. The computer program product of claim 12, wherein the first executable portion includes instructions for continuously storing the information in a circular buffer.

14. The computer program product of claim, 12, wherein the third executable portion includes instructions for controlling a continuous display of the information.

15. The computer program product of claim 14, wherein the third executable portion includes instructions for pausing, rewinding or fast forwarding a continuous display of the information.

16. The computer program product of claim 12, further comprising a fourth executable portion for displaying, in a historical sonar data window, a continuous representation of a predefined amount of the continuous record.

17. The computer program product of claim 16, further comprising a fifth executable portion for displaying, in a sonar display window, a more detailed representation of at least a portion of the continuous representation of the predefined amount of the continuous record in the historical sonar data window.

18. The computer program product of claim 17, further comprising a sixth executable portion for displaying, in a charted data window, a representation of navigation or detection data.

19. The computer program product of claim 18, wherein the fourth, fifth and sixth executable portions are executed such that the representation of navigation or detection data and the more detailed representation are simultaneously displayed with the continuous representation.

20. The computer program product of claim 17, further comprising a sixth executable portion for pausing the display of the more detailed representation, wherein pausing the display includes displaying a cursor at a location in the sonar display window, and simultaneously displaying a cursor at a corresponding location in the historical sonar data window.

21. The computer program product of claim 20, wherein the sixth executable portion includes instructions for displaying indicators in the historical sonar data window, the indicators being positioned at start and stop times for the more detailed representation in the sonar display window.

22. The computer program product of claim 17, further comprising a sixth executable portion for compressing at least a portion of the continuous representation in the historical sonar data window.

23. An apparatus for providing a sonar history, the apparatus comprising:
a storage media configured to store information associated with sonar signal data to thereby create a continuous record; and
a function execution element configured to receive an instruction from a user and to perform a function with respect to the continuous record, in response to, and based on the instruction,
wherein receiving the instruction and performing the function occur as the continuous record is created.

24. The apparatus of claim 23, wherein the storage media comprises a circular buffer.

25. The apparatus of claim 23, wherein the function execution element is configured to control a continuous display of the information.

26. The apparatus of claim 25, wherein the function execution element is configured to pause, rewind or fast forward a continuous display of the information.

27. The apparatus of claim 23, wherein the function execution element is configured to drive a display, in a historical sonar data window, of a continuous representation of a predefined amount of the continuous record.

28. The apparatus of claim 27, wherein the function execution element is configured to display, in a sonar display window, a more detailed representation of at least a portion of the continuous representation of the predefined amount of the continuous record in the historical sonar data window, the more detailed representation being simultaneously displayed with the continuous representation.

29. The apparatus of claim 28, wherein the function execution element is configured to display, in a charted data window, a representation of navigation or detection data.

30. The apparatus of claim 29, wherein the function execution element is configured to display the representation of navigation or detection data simultaneously with the continuous representation and the more detailed representation.

31. The apparatus of claim 28, wherein the function execution element is configured to pause the display of the more detailed representation, wherein pausing the display includes displaying a cursor at a location in the sonar display window, and simultaneously displaying a cursor at a corresponding location in the historical sonar data window.

32. The apparatus of claim 31, wherein the function execution element is configured to display indicators in the historical sonar data window, the indicators being positioned at start and stop times for the more detailed representation in the sonar display window.

33. The apparatus of claim 28, wherein the function execution element is configured to compress at least a portion of the continuous representation in the historical sonar data window.
